(19) United States
(12) Patent Application Publication
(10) Pub. No.: US 2024/0144163 A1
(43) Pub. Date: May 2, 2024

(54) MANAGEMENT METHOD

(71) Applicant: TOYOTA JIDOSHA KABUSHIKI KAISHA, Toyota-shi (JP)

(72) Inventors: Motohiro NAKAMURA, Okazaki-shi (JP); Toshiki KASHIWAKURA, Tokyo-to (JP); Yosuke TOGAMI, Nagoya-shi (JP); Yusuke KOBAYASHI, Tokyo-to (JP); Seii SAI, Yokohama-shi (JP); Tsuyoshi OKADA, Nagoya-shi (JP); Naoko YOKOYAMA, Tokyo-to (JP); Keishi KINOSHITA, Tokyo-to (JP)

(73) Assignee: TOYOTA JIDOSHA KABUSHIKI KAISHA, Toyota-shi (JP)

(21) Appl. No.: 18/495,754

(22) Filed: Oct. 27, 2023

(30) Foreign Application Priority Data
Nov. 1, 2022 (JP) 2022-175742

(51) Int. Cl. G06Q 10/0834; G06Q 10/0833

(52) U.S. Cl. CPC G06Q 10/0834; G06Q 10/0833

(57) ABSTRACT

A management method performed by a management apparatus includes determining a delivery vehicle based on vehicle classification data and delivery environment information.

### CROSS-REFERENCE TO RELATED APPLICATION

This application claims priority to Japanese Patent Application No. 2022-175742, filed on Nov. 1, 2022, the entire contents of which are incorporated herein by reference.

### TECHNICAL FIELD

The present disclosure relates to a management method.

### BACKGROUND

A method of calculating the shapes of packages and increasing a package loading rate is known (see, for example, Patent Literature (PTL) 1).

### CITATION LIST

### Patent Literature

PTL 1: JP 2020-173789 A

### SUMMARY

The overall efficiency of delivery work by vehicle is required to be improved.

It would be helpful to improve the overall efficiency of delivery work.

A management method according to an embodiment of the present disclosure is a management method performed by a management apparatus, the management method including determining a delivery vehicle based on vehicle classification data and delivery environment information.

According to a management method of an embodiment of the present disclosure, the overall efficiency of delivery work by vehicle can be improved.

### BRIEF DESCRIPTION OF THE DRAWINGS

In the accompanying drawings:

FIG. 1 is a block diagram illustrating an example configuration of a management system according to an embodiment; and

FIG. 2 is a flowchart illustrating an example procedure of a management method according to an embodiment.

### DETAILED DESCRIPTION

(Example Configuration of Management System 1)

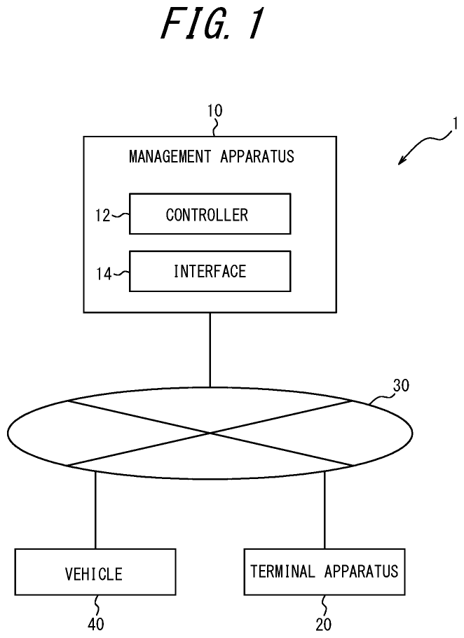

As illustrated in FIG. 1, a management system 1 according to an embodiment includes a management apparatus 10 and one or more vehicles 40. The vehicles 40 carry packages to be delivered. The management apparatus 10 manages operations of the vehicles 40 so as to increase the efficiency of delivery of the packages. The management apparatus 10 determines a vehicle 40 that delivers a package, in order to increase the efficiency of delivery of the packages.

The management system 1 further includes, but is not required to include, a terminal apparatus 20. The terminal apparatus 20 may be carried by a user who receives the package. The terminal apparatus 20 may be mounted in the vehicle 40 or may be carried by a driver of the vehicle 40. The terminal apparatus 20 may be configured to output the vehicle 40 determined by the management apparatus 10 and notify the driver. An example configuration of the management system 1 will be described below.

<Management Apparatus 10>

The management apparatus 10 includes a controller 12 and an interface 14.

The controller 12 controls at least one component of the management apparatus 10. The controller 12 may be configured to include at least one processor. The “processor” may include a general purpose processor, a dedicated processor specialized for specific processing, or the like in the present embodiment, but not limited to these. The controller 12 may be configured to include at least one dedicated circuit. The dedicated circuit may include, for example, a field-programmable gate array (FPGA) or an application specific integrated circuit (ASIC). The controller 12 may be configured with the dedicated circuit instead of the processor, or may be configured with the dedicated circuit along with the processor.

The management apparatus 10 may further include a memory. The memory is a semiconductor memory, a magnetic memory, an optical memory, or the like, for example, but not limited to these. The memory may function, for example, as a main memory, an auxiliary memory, or a cache memory. The memory may include an electromagnetic storage medium, such as a magnetic disk. The memory may include a non-transitory computer readable medium. The memory stores any information used for operations of the management apparatus 10. For example, the memory may store a system program, an application program, or the like. The memory may be included in the controller 12.

The interface 14 outputs information, data, or the like from the controller 12 to an external apparatus, and inputs information, data, or the like acquired from the external apparatus to the controller 12. The interface 14 may include a communication module that is configured communicably with the external apparatus, such as the vehicle 40 or the terminal apparatus 20, via a network 30. The communication module may be, for example, compliant with a mobile communication standard, such as the 4th Generation (4G) standard or the 5th Generation (5G) standard. The communication module may be compliant with a communication standard, such as a Local Area Network (LAN). The communication module may be compliant with a wired or wireless communication standard. The communication module is not limited to these examples and may be compliant with various communication standards. The interface 14 may be configured to be able to connect to a communication module.

The interface 14 may be configured to include an input device that accepts input of information, data, or the like from a user. The input device may be configured with, for example, a touch panel, a touch sensor, or a pointing device such as a mouse. The input device may be configured with a physical key. The input device may be configured with an audio input device, such as a microphone.

The interface 14 may be configured to include an output device that outputs information, data, or the like to the user. The output device may include, for example, a display device that outputs visual information, such as images, letters, or graphics. The display device may be configured with, for example, a Liquid Crystal Display (LCD), an organic or inorganic Electro-Luminescence (EL) display, a Plasma Display Panel (PDP), or the like. The display device is not limited to the above displays and may be configured with various other types of displays. The display device may be configured with a light emitting device, such as a Light Emitting Diode (LED) or a Laser Diode (LD). The display device may be configured with various other devices. The output device may include, for example, an audio output device, such as a speaker that outputs audio information, such as voice. The output device is not limited to the above examples and may include various other devices.

The management apparatus 10 may include a single server apparatus, or multiple server apparatuses capable of communicating with each other.

<Vehicle 40>

The vehicle 40 includes a vehicle body and a drive unit. The vehicle 40 is configured to load, into the vehicle body, articles to be delivered. The vehicle 40 may further include a controller that controls the drive unit. The vehicle 40 may be an engine vehicle or an electric vehicle. The engine vehicle may include an Internal Combustion Engine (ICE) vehicle. The electric vehicle may include a Hybrid Electric Vehicle (HEV), a Plug-in Hybrid Electric Vehicle (PHEV), a Fuel Cell Electric Vehicle (FCEV), or a Battery Electric Vehicle (BEV).

The vehicle 40 may further include a positional information detector that acquires positional information on the vehicle 40 itself. The vehicle 40 may output the positional information on the vehicle 40 itself to the management apparatus 10. The positional information detector may be configured to include a receiver compliant with a satellite positioning system. The receiver compliant with the satellite positioning system may include, for example, a Global Positioning System (GPS) receiver.

The number of vehicles 40 managed by the management system 1 may be two or more. The vehicle 40 may be configured to be operated by a driver or may be configured to travel by automated driving. When being operated by the driver, the vehicle 40 may include an in-vehicle apparatus, such as a navigation apparatus, that acquires an operation schedule from the management apparatus 10 and notifies the driver of the operation schedule. The operation schedule may be notified to the driver by the terminal apparatus 20 described below. When traveling by automated driving, the vehicle 40 may travel based on an operation schedule acquired from the management apparatus 10.

<Terminal Apparatus 20>

The terminal apparatus 20 may be configured to include one or more processors or one or more dedicated circuits. The terminal apparatus 20 may be configured to include a memory. The memory of the terminal apparatus 20 may be configured to be identical or similar to the memory of the management apparatus 10. The terminal apparatus 20 may be configured to include an interface or a communication module. The interface or communication module of the terminal apparatus 20 may be configured to be identical or similar to the interface or communication module of the management apparatus 10, respectively.

The terminal apparatus 20 may be configured to include an input device that accepts input of information, data, or the like from a user. The input device may be configured to include the various devices described as the interface 14. The terminal apparatus 20 may be configured to include an output device that outputs information, data, or the like to the user. The output device may be configured to include the various devices described as the interface 14.

The number of terminal apparatuses 20 included in the management system 1 is not limited to one and may be two or more. The terminal apparatus 20 may be configured as a mobile terminal, such as a smartphone or a tablet, or a Personal Computer (PC), such as a notebook PC or a tablet PC. The terminal apparatus 20 is not limited to the above examples and may include various devices.

(Example Operations of Management System 1)

In the management system 1 according to the present embodiment, the controller 12 of the management apparatus 10 determines the vehicle 40 that delivers the package, based on vehicle classification data on the vehicle 40 and delivery environment information. The vehicle 40 that delivers the package is also referred to as delivery vehicle.

<Determination of Delivery Vehicle Based on Impact of Delivery>

The controller 12 may determine the delivery vehicle based on the vehicle classification data and the delivery environment information, taking into account an impact of the delivery vehicle or delivery work on a delivery location.

The vehicle classification data on the vehicle 40 may include, for example, a classification based on the body size of the vehicle 40. The vehicle 40 may be classified according to the body size, for example, as very small, small, medium, large, or very large. The vehicle classification data on the vehicle 40 may include the size of an external shape, weight, or the like of the vehicle 40. The vehicle classification data on the vehicle 40 may include the minimum turning radius of the vehicle 40, the difference between inner or outer wheels thereof, or the like. Of the vehicle classification data on the vehicle 40, data regarding the external shape of the vehicle 40 can relate to the magnitude of an impact on other automobiles, motorcycles, pedestrians, or the like passing in the vicinity when the vehicle 40 is stopped at the delivery location.

The vehicle classification data on the vehicle 40 may include the size, position, or the like of a luggage carrier provided in the vehicle 40. The vehicle classification data on the vehicle 40 may include the capacity of packages loadable into the vehicle 40. Of the vehicle classification data on the vehicle 40, data regarding the luggage carrier of the vehicle 40 can relate to the magnitude of an impact on other automobiles, motorcycles, pedestrians, or the like passing in the vicinity when the vehicle 40 is stopped at the delivery location to handle the package. Of the vehicle classification data on the vehicle 40, data regarding the luggage carrier of the vehicle 40 can relate to the magnitude of an impact of noise occurring when the vehicle 40 is stopped at the delivery location to handle the package, on surrounding pedestrians, residents, or the like.

The vehicle classification data may include information identifying whether the vehicle 40 is powered by an engine or a motor. The vehicle classification data may include information identifying whether the vehicle 40 is an engine vehicle or an electric vehicle. The vehicle classification data may include information identifying whether the vehicle 40 is a refrigerated vehicle. The vehicle classification data may include information identifying whether the vehicle 40 is equipped with a compressor or the like to control the temperature of a luggage room. Of the vehicle classification data on the vehicle 40, data regarding a power source equipped in the vehicle 40 can relate to the magnitude of an impact of noise occurring when the vehicle 40 is stopped at the delivery location, on surrounding pedestrians, residents, or the like.

The vehicle classification data is information that does not change over time. The controller 12 may store the vehicle classification data on each vehicle 40 in the memory in advance.

The delivery environment information may include the delivery location, a delivery date and time, whether a package drop is acceptable, road data, a factor having an impact on time to stop the vehicle 40 during delivery, or the like. The delivery environment information can relate to the type or magnitude of an impact of the delivery vehicle or the delivery work on pedestrians, residents, or the like at the delivery location. The delivery environment information can relate to the sensitivity of the pedestrians, residents, or the like at the delivery location to the impact of the delivery vehicle or the delivery work. The type of the impact may include, for example, noise, traffic obstruction, or the like. The sensitivity to the impact of the delivery vehicle or the delivery work corresponds to ease of perception of noise, difficulty in passing, or the like due to the delivery vehicle or the delivery work. The delivery environment information may also include the probability of people, such as surrounding pedestrians or residents, communicating complaints to a delivery worker.

The controller 12 may determine the delivery vehicle so as to reduce the impact of the delivery vehicle or the delivery work on the surroundings at the delivery location. For example, the controller 12 may extract one or more vehicles 40 as candidates for the delivery vehicle. The vehicles 40 that are candidates for the delivery vehicle are also referred to as candidate vehicles. The controller 12 may estimate an impact on the surroundings when each of the candidate vehicles is stopped at the delivery location to perform the delivery work, and extract the candidate vehicles based on estimated results.

After extracting the candidate vehicles, the controller 12 may estimate the type or magnitude of the impact on the surroundings when each of the candidate vehicles is stopped at the candidate location and the delivery work is performed. The magnitude of the impact can be represented, for example, by the volume of noise, the rate of speed reduction of automobiles or other vehicles passing in the vicinity, or the like. The controller 12 may determine the delivery vehicle from among the candidate vehicles, based on estimated results of the type or magnitude of the impact of stopping each of the candidate vehicles at the delivery location.

The controller 12 may estimate time required to stop each of the candidate vehicles at the delivery location and deliver the package. In other words, the controller 12 may estimate time to stop each of the candidate vehicles. The controller 12 may determine the delivery vehicle from among the candidate vehicles, based on estimated results of the time to stop each of the candidate vehicles.

The controller 12 may determine the delivery vehicle from among the candidate vehicles, based on both the estimated results of the type or magnitude of the impact of stopping each of the candidate vehicles and the estimated results of the time to stop each of the candidate vehicles. The controller 12 may extract candidate vehicles whose estimated results of the time to stop is less than a predetermined time. The controller 12 may determine the delivery vehicle from among the extracted candidate vehicles, based on the estimated results of the type or magnitude of the impact. The controller 12 may also extract candidate vehicles whose magnitude of the impact of stopping is less than a predetermined value. The controller 12 may determine the delivery vehicle from among the extracted candidate vehicles so that the time to stop is minimized or less than a predetermined time.

The controller 12 may calculate a score representing the impact of stopping each candidate vehicle, based on the estimated result of the time to stop and/or the estimated result of the type or magnitude of the impact of stopping. In the present embodiment, the greater the impact of stopping a candidate vehicle on surrounding automobiles or people, the greater the controller 12 calculates the score for the candidate location.

The controller 12 may, for example, calculate the score with a higher value the longer a candidate vehicle is stopped. The controller 12 may, for example, calculate the score with a higher value the larger the external shape of a candidate vehicle or space occupied by handling packages. The controller 12 may, for example, calculate the score with a higher value the louder the engine or compressor sound produced by a candidate vehicle itself. The controller 12 may, for example, calculate the score with a higher value the louder the sound produced by handling packages. The controller 12 may calculate, as a value of the score, the product of the length of the time to stop a candidate vehicle and a value representing the magnitude of the impact.

The controller 12 may determine the delivery vehicle based on the calculated score. The controller 12 may determine, as the delivery vehicle, a candidate vehicle whose calculated score is minimized. The controller 12 may determine the delivery vehicle from among candidate vehicles whose calculated scores are less than a predetermined value.

The controller 12 may, conversely, calculate the score with a higher value the less the impact. In this case, the controller 12 may determine, as the delivery vehicle, a candidate vehicle whose calculated score is maximized. The controller 12 may determine the delivery vehicle from among candidate vehicles whose calculated scores are greater than or equal to a predetermined value.

The controller 12 may indicate, to the delivery worker, candidate vehicles whose impacts of stopping are low, with the terminal apparatus 20 or the interface 14. The delivery worker may use, as the delivery vehicle, a vehicle selected from the indicated candidate vehicles. The controller 12 may acquire information identifying the result of the selection from the candidate vehicles by the delivery worker with the terminal apparatus 20 or the interface 14.

As described above, the controller 12 can determine the delivery vehicle, taking into account the impact of the delivery vehicle or the delivery work at the delivery location. This reduces a mental burden on the delivery worker because the delivery worker is less likely to receive complaints from surrounding people or to be honked at by surrounding automobiles. Also, space for the delivery work can be sufficiently secured. In addition, the absence of congestion of people or automobiles in the vicinity makes it easier to move to the next location after a delivery is completed. As a result, the overall efficiency of the delivery work can be increased.

The controller 12 may determine the delivery vehicle based on stopping environment information. The stopping environment information may include the size of space for handling the package for the delivery, surrounding residents, traffic or noise, weather conditions, or the like. By determining the delivery vehicle based further on the stopping environment information, the vehicle 40 suited for the delivery can be used as the delivery vehicle. As a result, the overall efficiency of the delivery work can be increased.

<Operation Directions for Vehicle 40>

The controller 12 may determine an operation schedule for the determined delivery vehicle so that the delivery vehicle delivers the package. The controller 12 may direct the delivery vehicle to operate on the determined operation schedule.

<Notification of Expected Delivery Time>

As described above, the delivery vehicle or the delivery work can make the impact on the surroundings at the delivery location. Conversely, the delivery work can be impacted by the surroundings. For example, a delivery time can fluctuate due to an impact from the surroundings. The controller 12 may generate an estimated delivery time in a case in which the determined delivery vehicle is used to deliver the package. The controller 12 may generate the expected delivery time, as an expected delivery time period with a predetermined range. The controller 12 may determine, as the delivery vehicle, the vehicle 40 that is less susceptible to road conditions such as road congestion, for example, so that the expected delivery time period can be narrowed.

The controller 12 may notify the generated expected delivery time or expected delivery time period to the terminal apparatus 20 of the user who receives the delivery of the package. The terminal apparatus 20 may allow the user to enter whether the user can receive the package at the notified expected delivery time or expected delivery time period. The terminal apparatus 20 may output, to the management apparatus 10, delivery acceptability information notifying whether the delivery is acceptable at the expected delivery time or expected delivery time period. The controller 12 may acquire the delivery acceptability information from the terminal apparatus 20 and change the delivery vehicle when the delivery is not acceptable.

The controller 12 may generate an expected delivery time or an expected delivery time period in a case in which each candidate vehicle is used to deliver the package. The controller 12 may notify the terminal apparatus 20 of the user of the generated expected delivery times or expected delivery time periods in the cases of using the respective candidate vehicles for the delivery. The terminal apparatus 20 may allow the user to enter a time or time period at which the user can receive the package, among the notified expected delivery times or expected delivery time periods in the cases of using the respective candidate vehicles for the delivery. The terminal apparatus 20 may output, to the management apparatus 10, the delivery acceptability information notifying whether the delivery is acceptable at the expected delivery time or expected delivery time period in the case of using each candidate vehicle for the delivery. The controller 12 may acquire the delivery acceptability information from the terminal apparatus 20 and determine, as the delivery vehicle, a candidate vehicle that can make the delivery at the acceptable time or time period. After the delivery vehicle is determined, the controller 12 may generate a more limited expected delivery time or expected delivery time period and notify the terminal apparatus 20 of the user.

As described above, the controller 12 can determine the delivery vehicle by checking whether the user can receive the package at the expected delivery time or the expected delivery time period. This can increase the suitability of the delivery vehicle. In addition, the frequency of re-delivery can be reduced. The convenience of the user can therefore be improved. As a result, the overall efficiency of the delivery work can be increased.

<Example Procedure for Management Method>

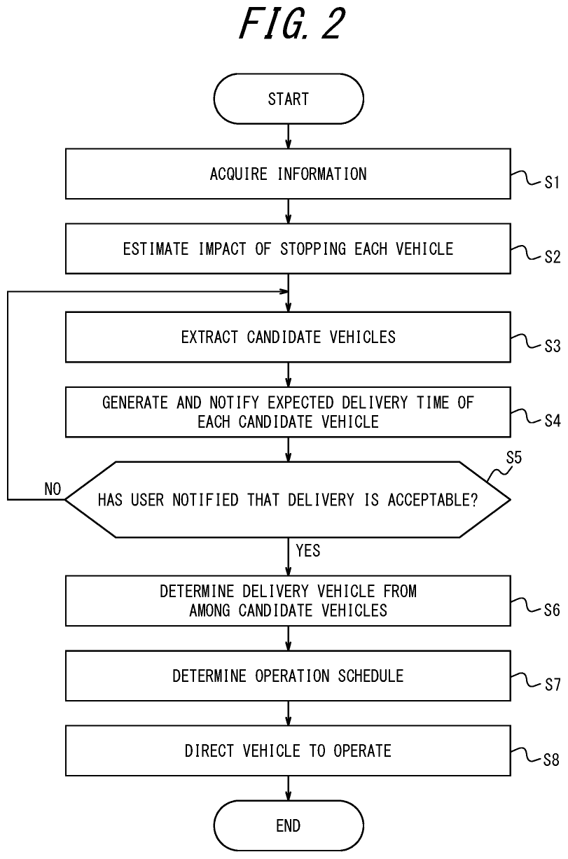

The controller 12 of the management apparatus 10 may, for example, perform a management method including a procedure of the flowchart illustrated in FIG. 2 to determine the delivery vehicle and direct operations. The management method may be implemented as a management program to be executed by the controller 12. The management program may be stored on a non-transitory computer readable medium.

The controller 12 acquires information, such as delivery environment information and vehicle classification data on the vehicles 40 (step S1). Based on the information acquired in step S1, the controller 12 estimates an impact of stopping each of the vehicles 40 at a delivery location (step S2). The controller 12 extracts candidate vehicles based on estimated results of step S2 (step S3). The controller 12 generates an expected delivery time or expected delivery time period in the case of using each of the candidate vehicles for delivery, and notifies the terminal apparatus 20 of a user who receives the delivery (step S5).

The controller 12 acquires delivery acceptability information from the terminal apparatus 20 and determines whether the user has notified that the delivery is acceptable (step S5). When the user has not notified that the delivery is acceptable (step S5: NO), i.e., the controller 12 receives notification from the user that the delivery is not acceptable, the controller 12 returns to step S3, i.e., the process of extracting candidate vehicles. When the user has notified that the delivery is acceptable (step S5: YES), the controller 12 determines a delivery vehicle, from among candidate vehicles whose delivery is notified to be acceptable by the user (step S6). The controller 12 determines an operation schedule for the delivery vehicle (step S7). The controller 12 directs the delivery vehicle to operate on the operation schedule determined in step S7 (step S8). After performing the process of step S8, the controller 12 ends the execution of the procedure of the flowchart in FIG. 2.

The procedure of the management method is not limited to the example procedure in the flowchart in FIG. 2 and may include other processes. Some of the processes in the example procedure in FIG. 2 may be omitted or the order may be interchanged. For example, after extracting the candidate vehicles, the controller 12 may estimate an impact of stopping each of the candidate vehicles at the delivery location. The controller 12 may also estimate, in the estimation process in step S2, an impact of each of the candidate vehicles stopped at the delivery location or an impact of delivery work. The controller 12 may further acquire stopping environment information in the information acquisition process in step S1.

### SUMMARY

As described above, the controller 12 of the management apparatus 10 can determine the delivery vehicle based on the vehicle classification data on the vehicles 40 and the delivery environment information. This reduces a mental burden on the delivery worker because the delivery worker is less likely to receive complaints from surrounding people or to be honked at by surrounding automobiles. Also, space for the delivery work can be sufficiently secured. In addition, the absence of congestion of people or automobiles in the vicinity makes it easier to move to the next location after a delivery is completed. The controller 12 can determine the delivery vehicle by checking whether the user can receive the package at the expected delivery time or the expected delivery time period. This can increase the suitability of the delivery vehicle. In addition, the frequency of re-delivery can be reduced. The convenience of the user can therefore be improved. As a result, the overall efficiency of the delivery work can be increased.

While embodiments of the present disclosure have been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A management method performed by a management apparatus, the management method comprising determining a delivery vehicle based on vehicle classification data and delivery environment information.

2. The management method according to claim 1, comprising determining the delivery vehicle based further on stopping environment information during delivery.

3. The management method according to claim 2, comprising:
extracting one or more candidate vehicles based on the vehicle classification data, the delivery environment information, and the stopping environment information; and
determining the delivery vehicle from among the candidate vehicles.

4. The management method according to claim 3, comprising:
estimating an impact of the delivery vehicle or an impact of delivery using the delivery vehicle; and
extracting the candidate vehicles based on an estimated result of the impact.

5. The management method according to claim 3, comprising:
generating an expected delivery time period for delivery using each of the candidate vehicles;
notifying a terminal apparatus of a user who receives the delivery of the expected delivery time period;
acquiring, from the terminal apparatus of the user, delivery acceptability information notifying whether the delivery is acceptable during the expected delivery time period; and
determining, based on the delivery acceptability information, the delivery vehicle from among the candidate vehicles.

6. The management method according to claim 4, comprising:
generating an expected delivery time period for delivery using each of the candidate vehicles;
notifying a terminal apparatus of a user who receives the delivery of the expected delivery time period;
acquiring, from the terminal apparatus of the user, delivery acceptability information notifying whether the delivery is acceptable during the expected delivery time period; and
determining, based on the delivery acceptability information, the delivery vehicle from among the candidate vehicles.
